(19) United States
(12) Patent Application Publication
(10) Pub. No.: US 2010/0050912 A1
(43) Pub. Date: Mar. 4, 2010

(54) METHOD FOR CONTROLLING THE OPERATION OF A ROTARY FURNACE BURNER

(75) Inventors: Matthias Mersmann, Lichtenbusch (BE); Gernot Jäger, Bergisch Gladbach (DE); Alexander Knoch, Lohmar (DE)

Correspondence Address: GREER, BURNS & CRAIN, 300 S WACKER DR, 25TH FLOOR, CHICAGO, IL, 60606, US

(73) Assignee: KHD HUMBOLDT WEDAG GMBH, Koeln (DE)

(21) Appl. No.: 12/520,097

(22) PCT Filed: Dec. 20, 2007
(86) PCT No.: PCT/EP2007/011248

§ 371 Date: Jun. 19, 2009

(30) Foreign Application Priority Data
Dec. 22, 2006 (DE) 10 2006 060 869.0

(51) Int. Cl. F23N 1/02; F23D 1/02; F27B 7/34; F27B 7/42

(52) U.S. Cl. 110/186; 110/188; 431/76; 110/264; 431/89; 432/105

(57) ABSTRACT

In order, for operating the lance burner of a rotary tubular furnace for the production of cement clinker from calcined raw cement meal, to provide an automated regulation method which is optimized in terms of the configuration of the burner flame for all types and quantities of fuels used, according to the invention a regulation method is proposed in which the characteristics of the burner flame are used as measurement variables, and the measurement variables are delivered to a controller which can vary at least three different manipulated variables of the burner, such as the spatial outflow angle and the swirl momentum of the swirled primary-airstream and/or the angle of divergence of the primary-air/jet-air jets emerging from individual nozzles and/or the velocity of emergence and/or swirl component of a stream of fragmentary alternative fuels or secondary fuels which is blown through the burner.

### BACKGROUND OF THE INVENTION

The invention relates to a method for regulating the operation of a burner for a rotary tubular furnace for the production of cement clinker, primary fuels, secondary fuels and primary-airstreams being blown out of the nozzle mouth of the burner, and state variables of the burner flame formed being measured, and the burner flame being varied as a function of these.

On a cement clinker production line, calcined raw cement meal is burnt in the sintering zone of a rotary tabular furnace to form cement clinker. To heat the rotary tubular furnace, a long burner lance is introduced into the furnace outflow end through the stationary furnace outflow housing, the fuels introduced into the lance burning at the issue of the latter so as to form a burner flame. The correct temperature, the length and the other configuration of the burner flame are important in the formation of clinker minerals in the rotary tubular furnace. Development tends towards giving the rotary tubular furnace itself as short a build as possible by virtue of the high-quality calcination of the raw cement meal outside the rotary tubular furnace, so that, in reaction to this, the burner flame is, as a rule, to be as short and as hot as possible. Increasingly often, instead of liquid and gaseous fuels, fuels used are solid fuels, in particular coal dust, but, recently, also pneumatically transportable fragmentary waste fuels, such as, for example, waste plastic granulates, etc., as what are known as secondary fuels.

Known rotary-furnace burners are often designed as what are known as three-duct burners (for example, DE-10 2004 010 063 A1), with at least three ducts concentric to one another, that is to say the pneumatically transported coal dust flows as fuel through the middle burner duct and emerges through an annular gap nozzle, the outflowing coal dust being surrounded by a radially inner and by a radially outer primary-airstream as combustion air. The radially outer air, also called jet air, is subdivided by means of a multiplicity of individual nozzles arranged in the annular jet-air duct into many individual high-velocity primary-air jets which generate a vacuum zone in their surroundings, that is to say the many high-velocity primary-air jets serve as propulsive jets of the injector principle, by virtue of which the large mass of the virtually stationary hot secondary air of, for example, about 1000° C., which surrounds the rotary-furnace burner, is sucked inwards in the direction of the core of the burner flame, where an intensive intermixing of the hot secondary air with the coal dust emerging through the annular gap nozzle takes place, which coal dust is to burn quickly and completely so as to form a short hot flame.

In the known rotary-furnace burner, the primary-air duct lying radially within the coal dust duct has at its issue a swirl generator which can be adjusted while the burner is in operation, the outflow angle of the swirl air and the flame form of the rotary-furnace burner being capable of being influenced by the adjustment of guide blades. An automated regulation concept is not known from this.

EP 1 518 839 A1 discloses a method for operating a cement clinker production plant, with sensors, for example cameras, for monitoring the characteristics of the flame of the rotary-furnace burner and using these measurement variables for automated regulation using a computer. In this case, only regulating actions on the mass or quantity flows of the raw cement meal with aggregates, supplied in each case, on the primary and secondary fuels and on the combustion air are known as manipulated variables.

In practice, for example when a larger burner flame has been required, the volume flows and the pressures of the primary air delivered to the rotary-furnace burner have been increased. This, however, results in undesirable effects, such as, for example, an increased wear of the refractory lining, increased rates of evaporation of disturbing pollutants and, above all, an increase in the specific heat energy consumption of the overall process. This is because, when a rotary-furnace burner is operating optimally, it is important to suck as much hot secondary air (for example, approximately 95% by volume) as possible into the core of the burner flame by means of as little cold primary air (for example, approximately 5% by volume) as possible for the purpose of rapid and complete fuel combustion. The fraction of cold primary air should, if possible, not be increased even when an increased fraction of fragmentary cost-effective alternative fuels or secondary fuels, such as, for example, waste plastic granulates, etc., is to be burnt in the rotary-furnace burner.

### SUMMARY OF THE INVENTION

The object on which the invention is based is, for operating the lance burner of a rotary tubular furnace for production of cement clinker from calcined raw cement meal, to provide an automated regulation method which is optimized in terms of the configuration of the burner flame for all fuels used, without regulating actions on the quantity or mass flows of the fuels supplied and/or on the combustion air and/or on the raw cement meal necessarily having to be carried out.

Whereas, in the known systems for regulating a rotary-furnace burner with monitoring of the burner flame, when regulation has been required the volume or mass flows of the primary air and/or of the fuels supplied to the burner have in any event been varied, which is undesirable since these fuel and combustion-airstreams have been set once in an optimal ratio to one another and coordinated with the overall cement clinker combustion process, in the regulation method according to the invention these volume or mass flows are initially not sensed, but, instead, regulating actions on manipulated variables of the burner itself, are carried out as a function of the measured characteristics of the burner flame. This presupposes that, in the regulation method according to the invention, the rotary-furnace burner affords the possibility of being able to vary a plurality of manipulated variables individually or simultaneously during operation, to be precise the spatial outflow angle and the swirl momentum of a swirled primary-airstream and/or the angle of divergence of the primary-air/jet-air jets emerging from individual nozzles distributed around the burner circumference and/or the velocity of emergence and/or the swirl component of a stream of fragmentary secondary fuels which is blown through the burner.

The measurement variables from the flame monitoring are delivered to an intelligent controller which, by means of logics, carries out the abovementioned regulating actions on the rotary-furnace burner, in such a way that, depending on the fuel, the burner flame assumes and maintains the desired configuration, while, especially, the particulate and fragmentary constituents of the solid fuels are also mixed completely into the flame cone and burnt out in the flame itself. Owing to the automated regulation of the burner towards an optimized burner flame tailored to the fuels used in each case and to the respective cement clinker combustion process, there is no need for any manual setting of the burner while the burner is in operation.

In the method according to the invention for regulating the operation of a rotary-furnace burner, in addition to the measurement variables of the properties of the burner flame, including its temperature, further measurement variables may be introduced as additional measurement variables into the control loop, such as, for example, the analysis of the rotary-furnace exhaust gas, in particular the CO and/or NOx content, and/or the temperature of the casing of the rotary tubular furnace and/or the temperature of the recuperation air from the clinker cooler, which flows as secondary air into the rotary furnace, and/or the current consumption of the rotary-furnace drive motor and/or characteristic numbers relating to the burn-out behaviour of the secondary fuels.

Insofar as the different regulating actions on the rotary-furnace burner have come up against their limits, there is the possibility, in addition to these regulating actions, of also carrying out a regulating action on the volume flows of the primary air and/or on the primary-air pressures and/or on the mass flows of the primary and secondary fuels used.

### BRIEF DESCRIPTION OF THE DRAWINGS

The invention and its further features and advantages are explained in more detail by means of the exemplary embodiment illustrated diagrammatically in the figures in which:

FIG. 1: shows diagrammatically an axial section through the center of the mouth of a rotary-furnace burner which offers at least three different manipulated variables and which is therefore basically suitable for carrying out the regulation method according to the invention, and

FIG. 2: shows, enlarged and in perspective, in more detail, the axial section through the burner mouth, partially in an end view, in order to explain the automated operation of the burner of a rotary tubular furnace for the production of cement clinker.

### DETAILED DESCRIPTION OF THE DRAWINGS

First, with reference to FIG. 2, the rotary-furnace burner suitable for the automated regulation method according to the invention is described. This is a four-duct burner with an annularly arranged duct 10 for the pneumatic transport of a fine-grained solid fuel, such as, for example, coal dust, as primary fuel, which flows out through an annular gap nozzle 11 at a low angle diverging outwards. The coal dust duct 10 is surrounded concentrically both by a radially inner and by a radially outer combustion-air duct, these combustion-airstreams for the burner forming the primary air, of which the fraction in the overall combustion air is to be as low as possible. The primary-air duct 12 arranged concentrically within the coal dust duct 10 is equipped at its issue with an adjustable swirl generator 13, for example with adjustable guide blades, swirl slots, etc., so that this radially inner primary-air duct is also called a swirl-air duct. The radially outer primary air, also called jet air, is supplied via jet-air tubes 14 arranged so as to be distributed axially parallel around the burner axis, and it emerges at high velocity in the form of nozzle jets from individual jet-air nozzles 15 arranged so as to be distributed around the circumference of the burner mouth and being, for example, twelve in number. The high-velocity jet-air jets, which are capable of sucking as much as possible of the hot secondary air of, for example, 1000° C., surrounding the rotary-furnace burner in the rotary tubular furnace, into the core of the burner flame for the purpose of rapid and complete fuel combustion, are to impinge upon the fuel cone or the burner flame at an optimum point for the purpose of achieving high flame turbulences.

In the annular space between the outer burner carrier tube 16 and the coal dust tube 17 arranged concentrically to it, cooling air is blown through the burner and flows out of the burner mouth in the region between the adjacent jet-air nozzles 15, where the cooling air heated at the burner lance can then also form a fraction of the primary air. The annular cooling-air duct is designated by the reference numeral 18. The burner carrier tube 16 is in any event protected in the front burner-lance region by an attached refractory compound, not illustrated in FIG. 2.

According to the exemplary embodiment of FIG. 2, for example, two tubes 19, 20 for the pneumatic transport and blow-out of fragmentary alternative fuels or secondary fuels, such as, for example, waste plastic granulates, etc., are introduced into the central tube of the burner, into which a central ignition burner and/or an oil burner can be inserted in the case of a conventional burner. An expansion chamber 21 open towards the burner mouth and having a widened cross section, as compared with the tube cross sections, is arranged in the burner in front of the issue of the tubes 19, 20 for blowing out the secondary fuels. That is to say, in this rotary-furnace burner, the fragmentary secondary fuels 25 injected via the tubes 19, 20 are first caused to emerge into the expansion chamber 21, out of which the fragmentary secondary fuels pre-oxidized there with a prolonged dwell time then enter the flame cone of the burner flame at the burner mouth with a markedly reduced velocity, the risk of fragmentary secondary fuel particles flying past the flame being minimized. Consequently, the quantity fraction of cost-effective fragmentary secondary fuels which can be used as energy carriers can be increased considerably, and part of the comparatively costly primary fuel can be saved.

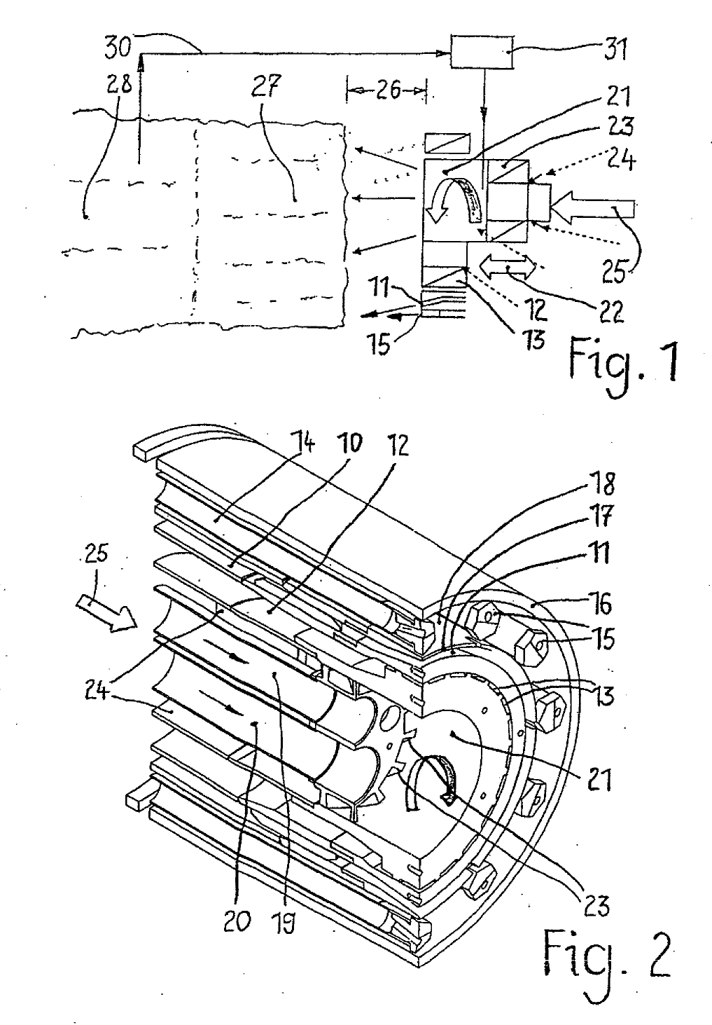

By means of an axial displacement of the secondary-fuel tubes 19, 20 which is indicated in FIG. 1 by the double arrow 22, the axial length and the volume of the expansion chamber 21 can be varied while the burner is in operation. Thus, the pre-oxidation, the velocity of emergence and the flight length of the fragmentary secondary-fuel particles blown out at the burner mouth and the configuration of the burner flame can be influenced.

The mixing of the blown-out fragmentary secondary fuels into the burner flame and the configuration of the latter can also be influenced in that a specific adjustable swirl generator 23 is arranged at the issue of the secondary-fuel tubes 19, 20 into the expansion chamber 21 in order to swirl the secondary fuels even in the expansion chamber 21. According to the exemplary embodiment of FIG. 2, this swirl generator 23 consists of a component which is attached to the issues of the secondary-fuel tubes 19, 20 and through which the secondary fuels flow and which has swirl slots which are distributed over the circumference and through which additional primary air blown through the burner flows, which primary air is introduced into the burner via the annular duct 24 and transmits its rotary momentum in the expansion chamber 21 to the blown-out fragmentary secondary fuels. This measure, too, contributes to ensuring that, in the rotary-furnace burner, the comparatively large quantity of fragmentary secondary fuels to be used does not fly past the burner flame in an undesirable way.

FIG. 1 illustrates diagrammatically the control loop of the automated regulation of the operation of the rotary-furnace burner. State variables of the burner flame 28 which are measured in the optical or infrared spectrum, in particular the flame length and flame thickness, are delivered via the signal line 30 to a controller 31 which, for the purpose of setting and maintaining an optimized flame configuration, can carry out regulating actions on one or more of the at least three different manipulated variables of the burner while the burner is in operation: on the adjustable swirl generator 13 for the radially inner primary-airstream in order to vary the spatial outflow angle and the swirl momentum of this primary air, and/or on the rotation of the jet-air nozzles 15 and, consequently, the change of the angle of divergence of this primary air, and/or on the displaceability 22 of the secondary-fuel tubes 19, 20, and on their swirl generator 23 in order to vary the flight length and/or swirl component of the blown-out fragmentary secondary fuels 25, which are symbolized in FIG. 1, as in FIG. 2, by the large arrow.

Furthermore, FIG. 1 illustrates diagrammatically that not only the flame configuration, but also the desired distance 26 from the start of the flame root 27 to the burner mouth, can be set, even while the burner is in operation, for example, in a range of about 300 to about 800 mm, with the aid of the adjustable axial length of the expansion chamber 21 and of the rotary momentum of the blown-out secondary fuels 25 and, if appropriate, as a function of further parameters. This desired distance 26 is found as an optimum between a long distance, with a high degree of care in terms of material, of the flame root 27 from the burner mouth and a short distance, desired in combustion terms, between the flame root and the burner mouth.

The regulation method according to the invention is not restricted to the use of a burner according to exemplary embodiments shown in FIGS. 1 and 2. Thus, instead of coal dust, oil may also be used as primary fuel, if coal dust is not available. The swirl-air duct may also be arranged radially outside the primary-fuel duct, instead of radially inside it, and the radially inner primary air could, if appropriate, even be dispensed with.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1-3. (canceled)

4. A method for regulating the operation of a burner for a rotary tubular furnace in which primary fuels, secondary fuels and primary-airstreams are blown out of a nozzle mouth of the burner, state variables of a form of a flame of the burner are measured, and the burner flame is varied as a function of the measured state variables comprising the steps:
measuring characteristics of the burner flame, including at least one of a length and a thickness of the burner flame, as measurement variables;
regulating the burner by adjusting at least one of a spatial outflow angle and a swirl momentum of a swirled primary-airstream, an angle of divergence of primary-air/jet-air jets emerging from individual nozzles distributed around a circumference of the burner, a velocity of emergence, and a swirl component of a stream of fragmentary secondary fuels which is blown through the burner;
wherein the regulating step is carried out in an automated manner via a controller for the purpose of an optimized configuration of the burner flame.

5. The method according to claim 4, further including the step of introducing further measurement variables as additional measurement variables into the control loop, such as further measurement variables being selected from the group consisting of an analysis of the CO or NOx content of the rotary-furnace exhaust gas, the temperature of the casing of the rotary tubular furnace, the temperature of the recuperation air from the clinker cooler, which flows as secondary combustion air into the rotary tubular furnace, the current consumption of the rotary-furnace drive motor, and characteristic numbers relating to the burn-out behaviour of the secondary fuels.

6. The method according to claim 4, further including the step of regulating at least one of volume flows of the primary air, a pressure of the primary-air pressures, mass flows of the primary fuels used and mass flows of the secondary fuels used.

7. A method for regulating the operation of a burner for a rotary tubular furnace comprising the steps:
blowing primary fuels out of a nozzle mouth of the burner,
blowing secondary fuels out of the nozzle mouth,
blowing primary-airstreams out of the nozzle mouth,
measuring state variables of a form of a flame of the burner, including at least one of a length and a thickness of the burner flame, as measurement variables;
varying the burner flame as a function of the measured state variables, by adjusting at least one of a spatial outflow angle and a swirl momentum of a swirled primary-airstream, an angle of divergence of primary-air/jet-air jets emerging from individual nozzles distributed around a circumference of the burner, a velocity of emergence, and a swirl component of a stream of fragmentary secondary fuels which is blown through the burner;
wherein the varying step is carried out in an automated manner via a controller for the purpose of an optimized configuration of the burner flame.

8. The method according to claim 7, further including the step of introducing additional measurement variables to the controller, such further measurement variables being selected from the group consisting of an analysis of the CO or NOx content of the rotary-furnace exhaust gas, the temperature of the casing of the rotary tubular furnace, the temperature of the recuperation air from the clinker cooler, which flows as secondary combustion air into the rotary tubular furnace, the current consumption of the rotary-furnace drive motor, and characteristic numbers relating to the burn-out behaviour of the secondary fuels.

9. The method according to claim 7, further including the step of regulating volume flows of the primary air through the burner.

10. The method according to claim 7, further including the step of regulating a pressure of the primary-air pressures introduced to the burner.

11. The method according to claim 7, further including the step of regulating mass flows of the primary fuels introduced to the burner.

12. The method according to claim 7, further including the step of regulating mass flows of the secondary fuels introduced to the burner.
